(19) United States
(12) Patent Application Publication
(10) Pub. No.: US 2016/0328184 A1
(43) Pub. Date: Nov. 10, 2016

(54) PERFORMANCE OF STORAGE CONTROLLERS FOR APPLICATIONS WITH VARYING ACCESS PATTERNS IN INFORMATION HANDLING SYSTEMS

(71) Applicant: Dell Products L.P., Round Rock, TX (US)

(72) Inventors: Dharmesh Maganbhai Patel, Round Rock, TX (US); Rizwan Ali, Cedar Park, TX (US)

(21) Appl. No.: 14/706,639

(22) Filed: May 7, 2015

(51) Int. Cl. G06F 3/06

(52) U.S. Cl. CPC G06F 3/0689; G06F 3/0604; G06F 3/064; G06F 3/0664

(57) ABSTRACT

A storage controller may receive a first data block from a first application and a second, larger data block from a second application. The storage controller may write the first data block to a first data stripe spanning a plurality of data storage resources associated with a virtual storage disk based on a size of the first data block. The storage controller may also write the second data block to a second data stripe spanning the plurality of data storage resources based on a size of the second data block. The first stripe may each include one stripe element of a first stripe element size on each of the data storage resources and the second stripe may include one stripe element of a second, larger stripe element size on each of the data storage resources.

### BACKGROUND

1. Field of the Disclosure

This disclosure relates generally to information handling systems and more particularly to improving the performance of storage controllers in information handling systems having applications with varying access patterns.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may process, store, and communicate information and may include one or more computer systems, data storage systems, and networking systems.

In various information handling systems, data may be stored on a virtual storage disk that includes a plurality of data storage resources such as hard disk drives (HDDs) or solid state drives (SSDs). The virtual storage disk may be associated with a storage controller configured to receive and execute instructions. For example, various applications running on the information handling system may provide the storage controller with instructions to write data to the virtual storage disk and/or to read data from the virtual storage disk.

### SUMMARY

In accordance with one embodiment, the present disclosure may include a method comprising receiving, by a storage controller, a first data block from a first application and receiving, by the storage controller, a second data block larger than the first data block from a second application. The method may also comprise writing, by the storage controller based on a size of the first data block, the first data block to a first data stripe spanning a plurality of data storage resources associated with a virtual storage disk, the first data stripe including one stripe element of a first stripe element size on each of the plurality of data storage resources. The method may additionally include writing, by the storage controller based on a size of the second data block, the second data block to a second data stripe spanning the plurality of data storage resources, the second data stripe including one stripe element of a second stripe element size on each of the plurality of data storage resources. In the method, the second stripe element size may be larger than the first stripe element size.

Another embodiment of the present disclosure may include an apparatus comprising a processor and a computer-readable medium comprising instructions. The instructions, when read and executed by the processor, may be configured to cause the processor to receive a first data block from a first application and receive a second data block larger than the first data block from a second application. The instructions, when read and executed by the processor, may be additionally configured to cause the processor to write, based on a size of the first data block, the first data block to a first data stripe spanning a plurality of data storage resources associated with a virtual storage disk, the first data stripe including one stripe element of a first stripe element size on each of the plurality of data storage resources. The instructions, when read and executed by the processor, may be further configured to cause the processor to write, based on a size of the second data block, the second data block to a second data stripe spanning the plurality of data storage resources, the second data stripe including one stripe element of a second stripe element size on each of the plurality of data storage resources. In the apparatus, the second stripe element size may be larger than the first stripe element size.

An additional embodiment of the present disclosure may include an article of manufacture comprising a machine-readable medium and instructions on the machine-readable medium that. The instructions, when read and executed by a processor, may be configured to cause the processor to receive a first data block from a first application and receive a second data block larger than the first data block from a second application. The instructions, when read and executed by a processor, may be configured to also cause the processor to write, based on a size of the first data block, the first data block to a first data stripe spanning a plurality of data storage resources associated with a virtual storage disk, the first data stripe including one stripe element of a first stripe element size on each of the plurality of data storage resources. The instructions, when read and executed by a processor, may be configured to further cause the processor to write, based on a size of the second data block, the second data block to a second data stripe spanning the plurality of data storage resources, the second data stripe including one stripe element of a second stripe element size on each of the plurality of data storage resources. In the article of manufacture, the second stripe element size may be larger than the first stripe element size.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates an example system using improved performance of a storage controller, in accordance with some embodiments of the present disclosure;

FIG. 2 illustrates an example of a virtual storage disk, in accordance with some embodiments of the present disclosure;

FIG. 3 illustrates an example of a physical storage disk, in accordance with some embodiments of the present disclosure; and

FIG. 4 illustrates an example method, in accordance with some embodiments of the present disclosure.

### DESCRIPTION OF PARTICULAR EMBODIMENT(S)

The present disclosure relates to improvements in storage optimization. In some embodiments, a storage controller may receive a block of data from an application to write to a virtual storage disk. The storage controller may write the block of data to a particular stripe region of the virtual storage disk, and the particular stripe region may be associated with a stripe of data of a certain size. The storage controller may map the write location of the block of data to a stripe element location in the particular stripe region of the virtual disk. The stripe regions may be based on a common block size for applications.

Throughout this disclosure, an alphabetic character following a numeral form of a reference numeral refers to a specific instance of an element and the numerical form of the reference numeral refers to the element generically. Thus, for example, device “12a” refers to an instance of a device class, which may be referred to collectively as devices “12” and any one of which may be referred to generically as a device “12”.

In the following description, details are set forth by way of example to facilitate discussion of the disclosed subject matter. It should be apparent to a person of ordinary skill in the field, however, that the disclosed embodiments are exemplary and not exhaustive of all possible embodiments.

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a server, a personal computer, a PDA, a consumer electronic device, a network storage device, or another suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

Additionally, the information handling system may include firmware for controlling and/or communicating with, for example, hard drives, network circuitry, memory devices, I/O devices, and other peripheral devices. As used in this disclosure, firmware includes software embedded in an information handling system component used to perform predefined tasks. Firmware is commonly stored in non-volatile memory, or memory that does not lose stored data upon the loss of power. In some examples, firmware associated with an information handling system component is stored in non-volatile memory that is accessible to one or more information handling system components. In the same or other examples, firmware associated with an information handling system component is stored in non-volatile memory that is dedicated to and comprises part of that component.

For the purposes of this disclosure, computer-readable media may include an instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), a compact disk, a CD-ROM, a DVD, random access memory (RAM), read-only memory (ROM), an electrically erasable programmable read-only memory (EEPROM), and/or a flash memory device such as a solid state drive (SSD). Computer-readable media may also include communications media such as wires, optical fibers, microwaves, radio waves, and other electromagnetic and/or optical carriers, and/or any combination of the foregoing.

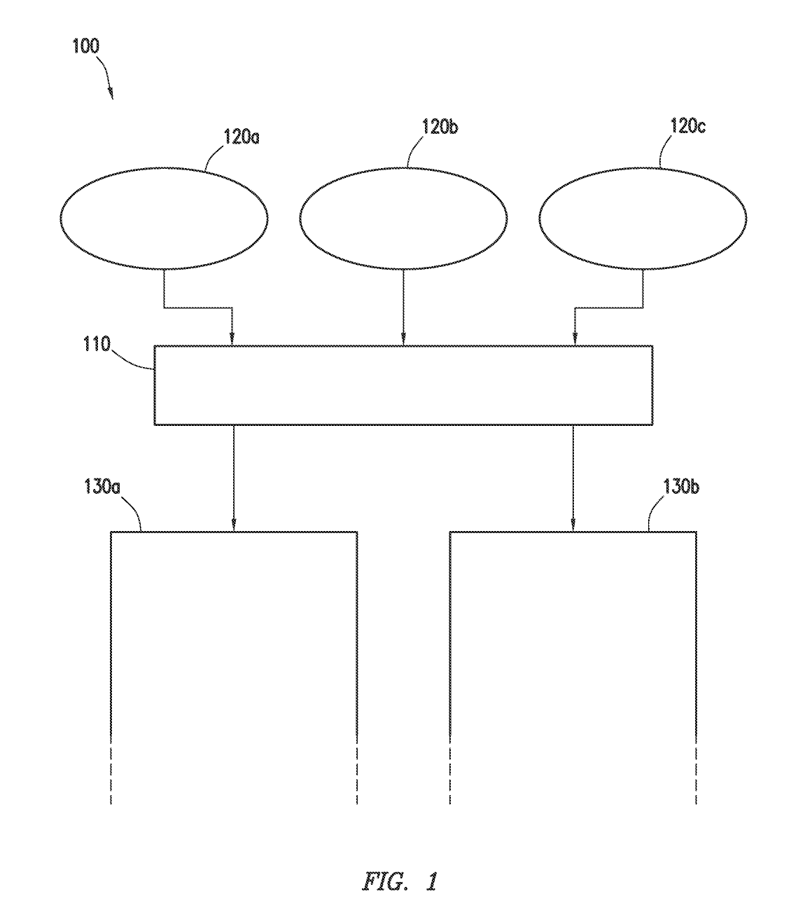

Particular embodiments are best understood by reference to FIGS. 1-4 wherein like numbers are used to indicate like and corresponding parts.

FIG. 1 illustrates an example system using improved performance of a storage controller in accordance with some embodiments of the present disclosure. System 100 may include a storage controller 110, one or more applications 120 (for example, applications 120a, 120b, and 120c), and one or more virtual storage disks 130 (for example, virtual storage disks 130a and 130b). Applications 120 may send write requests of data blocks to storage controller 110. Storage controller 110 may write the data bocks from applications 120 as data stripes to virtual storage disks 130. A data block may refer to any length or portion of data designated by an application 120 to be stored in system 100. In some embodiments, it may be desirable to store the data block in a single contiguous physical location, but it need not be so stored.

Virtual storage disks 130 may include one or more physical storage media grouped together to function as one or more logical units of storage, or may include a portion of a physical storage media designated to operate as a logical unit of storage. While FIG. 1 illustrates two virtual storage disks 130, it will be appreciated that any number of virtual storage disks may be used and any number of physical storage disks may be used to make up the virtual storage disks. By way of non-limiting example, five hard disk drives may be grouped into three virtual storage disks accessible by one or more information handling systems. As another example, a single physical storage disk may have multiple partitions or other demarcations designating various regions of the physical storage disk as multiple virtual storage disks 130.

Virtual storage disk 130 may utilize any of a variety of protection schemes for the data stored on the disk. For example, virtual storage disk 130 may include a redundant array of independent disks (RAID) across the physical drives. This may include any of a variety of RAID technologies, including but not limited to striping (RAID 0), mirroring (RAID 1), mirroring with striping (RAID 10), and striping with parity (RAID 5/6). The term striping may refer to a process by which data is broken into stripe elements, each successive stripe element being placed on a separate physical storage disk. For example, if a stripe of one hundred and twenty-eight kilobytes (KB) spanned two physical drives, there would be two distinct sixty-four KB stripe elements, one on each of the physical drives. In the preceding example, the stripe element size is sixty-four KB. A data block from a read/write request may correspond to a single stripe element (one to one correspondence of data block to stripe element); a data block from a read/write request may span multiple stripe elements (one to many correspondence of data block to stripe elements); or multiple data blocks from a read/write request may correspond to a single stripe element (many to one correspondence of data blocks to stripe element). By using a protection scheme, storage controller 110 may write data across multiple physical storage disks. For example, if RAID 6 were used across five physical storage disks, and a stripe segment were sixty-four KB, a single stripe may include three data blocks of sixty-four KB and two parity blocks of sixty-four KB for Aₚ and A_{q}, each of these five stripe segments being written on a distinct and separate physical storage disk. While storage controller 110 waits for the remaining write requests to complete a stripe, storage controller 110 may cache the received data block until sufficient data blocks to complete a stripe are received.

In some embodiments, during the initial configuration of virtual storage disks 130, the virtual storage disk 130 may be divided into a plurality of stripe regions for storage based on data block size. A stripe region may include a particular region of a physical storage disk and/or a virtual storage disk where a contiguous set of stripes are written that have a similar or same stripe element size. For example, a first stripe region may be configured to include stripe elements of a first small size, a second stripe region may be configured to include stripe elements of a second medium size, and a third stripe region may be configured to include stripe elements of a third large size. Any number of stripe regions may be included, and any size range may be included in the stripe element size. For example purposes only, the present disclosure may reference three stripe regions, with the first stripe region comprising data blocks of a size spanning four kilobytes (KB) to sixty-four KB, the second stripe region comprising data blocks of a size spanning sixty-four KB to two hundred and fifty-six KB, and the third stripe region comprising data blocks of a size spanning two hundred and fifty-six KB to five hundred and twelve KB. It will be appreciated that the number of stripe regions and the range of data block sizes for the stripe region may be any desired value. For example, five stripe regions may be used, including a first region with a maximum data block size of sixty-four KB, a second region with a maximum data block size of one hundred and twenty-eight KB, a third region with a maximum data block size of two hundred and fifty-six KB, a fourth region with a maximum data block size of five hundred and twelve KB, and a fifth region with a maximum data block size of one megabyte (MB).

In some embodiments, the configuration of regions may be manually selected during the initial configuration of the virtual storage disks 130, which may include the formatting or partitioning of the physical disks comprising the virtual storage disks 130. This may occur through a pre-selected set of questions that a user may answer, for example, asking the typical uses and applications the user intends for virtual storage disk 130. This may also occur through a user selecting the number of regions and a maximum size or size range associated with each region. Each of the respective stripe regions may be configured to store stripes of data including data blocks of the size configured to be stored within that region. For example, one or more blocks of data corresponding to the first small stripe region may be written as a stripe of data within that first stripe region.

Storage controller 110 may receive write requests from applications 120a-120c to write a data block to one or more virtual storage disks 130. Storage controller 110 may then determine to which stripe region to write, based on the size of the data block. If there is sufficient data to complete a stripe of the appropriate size for the given stripe region, storage controller 110 may then write the stripe including the data block just received. If not, storage controller 110 may cache the data block until a sufficient number of write requests of a particular stripe region have been received to complete a stripe.

The size of the data block in a write request may be determined or presumed in any of a number of ways. By way of example, this may include the write request itself identifying the size of the data block to be written. This may additionally include storage controller 110 monitoring the data block size for a write request. This may also include storage controller 110 determining the normal write request size of a given application and presuming that the size of the data block received in a write request is consistent with the normal write request size. The normal write request size may be determined based on a history of write request sizes for a given application, and may be continuously or periodically monitored to determine the normal write request size. The normal write request size may also be determined based on an application reporting its preferred write request size. The normal write request size may also be determined based on the class of the application. For example, an operating system or file system may have a normal write size corresponding to the smallest stripe region and traditional applications may have a normal write size corresponding to the medium or large stripe region. If the normal write request size approach is utilized, the storage control module 110 need not analyze the size of the write request for each request before determining to which stripe region the data block from the write request belongs.

In some embodiments, storage controller 110 may adapt to an application's write request size pattern changes. For example, if storage controller 110 periodically monitors a given application, that application's write request size pattern may originally be in the medium size stripe region. Over time, the application's write request size may change to more optimally use the large size stripe region. A non-limiting example of such an application that might change over time is an email applications. An email application's write requests may change as attachments and email sizes increase over time. By periodically monitoring applications' write size requests, storage controller 110 may be aware of any change and may modify what the presumed normal write size request is for the applications. An application 120 may also self-report such a change to storage controller 110, or contain a setting indicating such a change, detectable by storage controller 110. This may be implemented, for example, in a software version update for an application.

In some embodiments, once an application 120 has changed its normal write size request and that change has been recognized by storage controller 110 (using any of the methods described above), storage controller 110 may migrate any data blocks written to virtual storage disk 130 from its previous size stripe region to its new size stripe region. By way of example, consider a given application whose write requests originally were written in the medium size stripe region, and the application's normal write size request changed such that the application's normal write size request now belongs to the large size stripe region. Storage controller 110 may migrate the data blocks already written in the medium size stripe region over to the large size stripe region to conform with the application's new size of stripe region.

It will be appreciated that any number of applications 120 may correspond to storage controller 110. By way of non-limiting example, in the context of virtual machines, there may be multiple operating systems, each running multiple traditional applications, and each of these operating systems and traditional applications may be sending write requests to storage controller 110. In like manner, storage controller 110 may manage any number of virtual storage disks 130. By way of another non-limiting example, storage controller 110 may manage five virtual storage disks 130, each comprising multiple physical disks, and each of the virtual storage disks 130 utilizing a different type of RAID protection scheme.

Storage controller 110 may maintain a data mapping table of data blocks to stripe segment locations. For example, storage controller 110 may map three data blocks corresponding to the small stripe region as stripe segments in a particular stripe in the small stripe region. This data mapping table may include information indicating where in a particular stripe a block of data has been stored, to what type of region the stripe belongs (for example, small, medium or large), and what virtual storage disk the data block has been stored on.

In some embodiments, storage controller 110 may utilize a region mapping table. In such an embodiment, the region mapping table may map physical sectors or tracks of a physical storage disk to a stripe region. For example, such a table may designate a number of tracks proximate the outer diameter of an annular hard disk platter as a large size stripe region and may designate a number of tracks proximate the inner diameter of the annular hard disk platter as a small size stripe region. In some embodiments, this region mapping table may be generated during the initial configuration of the physical storage disks, designating certain physical tracks or sectors as corresponding to a particular size of stripe region.

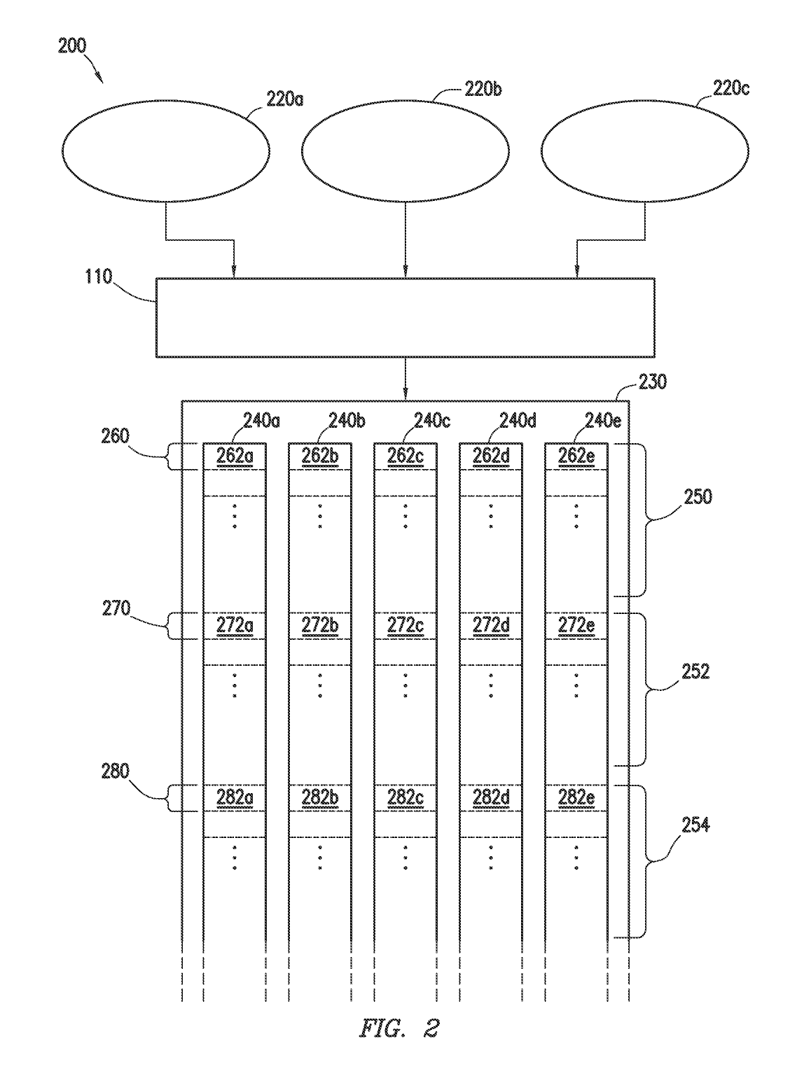

FIG. 2 illustrates an example of a virtual storage disk, in accordance with some embodiments of the present disclosure, for example the virtual storage disk from FIG. 1. This example is purely for illustrative purposes in explaining some principles of the present disclosure. The system 200 of FIG. 2 includes storage controller 110, three applications 220a-220c, and one virtual storage disk 230. Virtual storage disk 230 includes five physical storage disks 240a-e. Virtual storage disk 230 employs RAID 6 protection. Virtual storage disk 230 includes three sizes of stripe regions: a small size stripe region 250, a medium size stripe region 252, and a large size stripe region 254.

For convenience in describing the operation in FIG. 2, it will be assumed that application 220a utilizes a small size of write requests, or in other words, the write requests from application 220a are typically between four KB and sixty-four KB; it will be assumed that application 220b utilizes a medium size of write requests, or in other words, the write requests from application 220b are typically between sixty-four KB and two hundred and fifty-six KB; and it will be assumed that application 220c utilizes a large size of write requests, or in other words, the write requests from application 220c are typically between two hundred and fifty-six KB and five hundred and twelve KB. These are merely illustrative and are in no way meant to be limiting.

When storage controller 110 receives a write request from application 220a, it determines to what size stripe region the data should go. This may include any of the methods described above. For example, it may include monitoring or reading the data block size of the write request, or may include looking up what the normal write size request is for application 220a. In the present example, storage controller 110 determines that write requests from application 220a should be written in small size stripe region 250. Storage controller 110 then caches the data block until it has received enough write requests to complete an entire stripe of data in that region, for example stripe 260. In small size stripe region 250, using RAID 6, the data available for a given stripe is three times the stripe segment size, with the segment size being sixty-four KB in the present example. In other words, storage controller 110 may wait until it has received one hundred and ninety-two KB of write request data before writing stripe 260. The stripe would also include two parity stripe segments corresponding to Aₚ and A_{q}, each of those stripe segments also being sixty-four KB. Storage controller 110 writes one segment of the stripe to each of physical storage disks 240, for example: stripe element 262a may be on physical storage disk 240a, stripe element 262b may be on physical storage disk 240b, stripe element 262c may be on physical storage disk 240c (stripe elements 262a, 262b, and 262c representative of data from application 220a write requests), stripe element 262d may be on physical storage disk 240d and stripe element 262e may be on physical storage disk 240e (stripe elements 262d and 262e may represent Aₚ and A_{q}). Once stripe 260 has been written, storage controller 110 may then update a data mapping table indicating what data block or blocks are stored in a particular stripe segment. This mapping table may be divided or organized based on size stripe region. Storage controller 110 may then await additional write requests.

In embodiments in which a data block and stripe element have a one to one correlation, the process of determining whether or not sufficient data has been received may be slightly different. In such an embodiment, storage controller 110 may analyze the number of data blocks received, rather than the volume of data received. Thus, in the example above, once three data blocks were received, regardless of their size, storage controller 110 may write the stripe including the three data blocks, each occupying one stripe segment. Such an approach may reduce the overhead processing performed by storage controller 110 because it need not analyze the size of write requests or the accumulated total. However, there may be some efficiency tradeoffs because a certain stripe segment may not be completely full. For example, consider small size stripe region with a maximum write block size of sixty-four KB and three stripe segments of data per stripe, utilizing a one to one correlation of data blocks to stripe segments. If three consecutive four KB data blocks were received, twelve KB of data would be stored across the stripe reserving one hundred and ninety-two KB of space.

To continue the example from above and turning to the medium size stripe region, if storage controller 110 receives a write request from application 220b, storage controller 110 determines to what size stripe region that data block belongs. In the present example, application 220b is presumed to correspond to medium size stripe region 252. Storage controller 110 may then cache the data block until it receives enough write requests to complete an entire stripe in the medium size stripe region 252 of virtual storage disk 230, for example, stripe 270. Once enough write requests are received (for example, additional write requests from application 220b), storage controller 110 may write the entire stripe 270, including the parity segments, to medium size stripe region 252, with one segment of the stripe on each of physical storage disks 240a-e, for example: stripe element 272a may be on physical storage disk 240a, stripe element 272b may be on physical storage disk 240b, stripe element 272c may be on physical storage disk 240c (stripe elements 272a, 272b, and 272c representative of data from application 220a write requests), stripe element 272d may be on physical storage disk 240d and stripe element 272e may be on physical storage disk 240e (stripe elements 272d and 272e may represent Aₚ and A_{q}). Storage controller 110 may then await additional write requests.

Lastly, if storage controller 110 receives a write request from application 220c, storage controller 110 determines to what size stripe region the data belongs. As expressed above, application 220c corresponds to large size stripe region 254, and storage controller 110 may so determine based on any of the approaches above. Storage controller 110 may cache the data block until enough data blocks have been received to fill a stripe in large size stripe region 254, for example, stripe 280. Once there is sufficient data, storage controller 110 then writes the data blocks in stripe 280 in large size stripe region 256 across the five physical storage disks 240a-e, for example: stripe element 282a may be on physical storage disk 240a, stripe element 282b may be on physical storage disk 240b, stripe element 282c may be on physical storage disk 240c (stripe elements 282a, 282b, and 282c representative of data from application 220a write requests), stripe element 282d may be on physical storage disk 240d and stripe element 282e may be on physical storage disk 240e (stripe elements 282d and 282e may represent Aₚ and A_{q}). Storage controller 110 may then await additional write requests.

It will be appreciated that for the example illustrated in FIG. 2, the number of applications, the number of virtual disks, the number of regions, the type of RAID used, and the size of the regions are merely illustrative and are in no way limiting. For example, there may be a plurality of applications that correspond to a given size of stripe region. Thus, it is not necessarily the case in which one application has a dedicated region of a virtual storage disk (although that may be the practical result of using the teachings of the present disclosure). Rather, a particular region of a virtual storage disk may be designated to receive data corresponding to a particular size of data blocks.

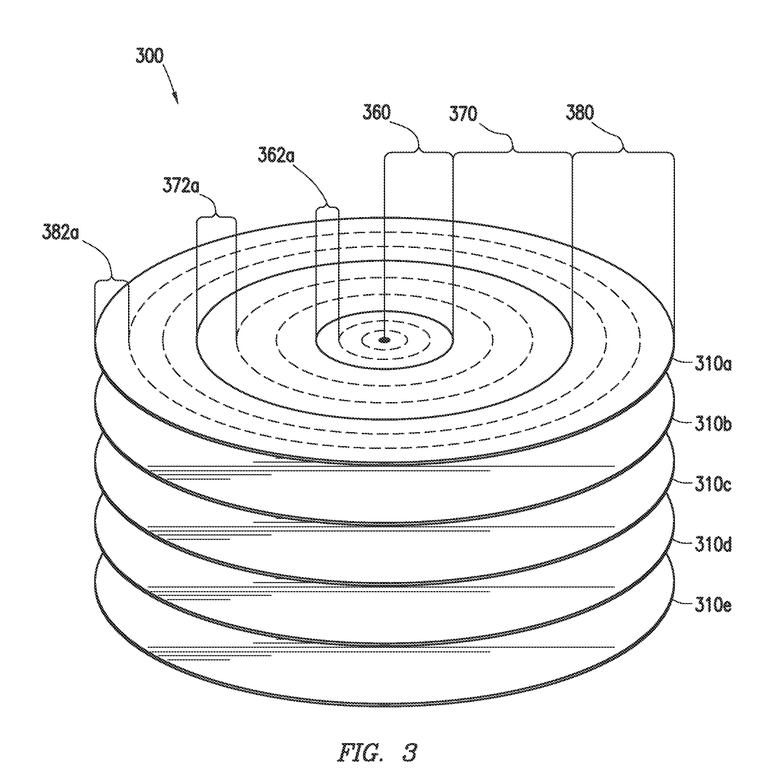

FIG. 3 illustrates an example of a physical storage disk, in accordance with some embodiments of the present disclosure. In some configurations, a physical storage disk 300 may include one or more annular hard disk platters 310a-e upon which data is written. For each given annular hard disk platter, for example annular hard disk platter 310a, the largest size of stripe region may be on the outer circumferential region of annular hard disk platter 310a, while the smallest size of stripe region may be on the inner circumferential region of annular hard disk platter 310a. Stated another way, a smaller sized stripe region may be located proximate the inner diameter of annular hard disk platter 310a, while a larger sized stripe region may be located proximate the outer diameter of annular hard disk platter 310a. In this way, when reading or writing larger pieces of data, a head of physical storage disk 300 may address a larger portion of a particular read or write command without moving the head. For example, the probability may be higher that the entire data block is on a single track of the physical storage disk. This may increase the efficiency of read/write requests because the head has to move less for the larger data read/write requests. Because the data segments for the read/write requests are smaller in the smaller stripe regions, the smaller circumference of readable area on the inner region of annular hard disk platter 310a is not as likely to require movement of the head to read the data segment from the smaller size stripe region. Stated another way, because the data blocks in the large size stripe regions are large, they take up a larger portion of a given circumferential region of annular hard disk platter 310a. By placing larger stripe segments on the outer regions of annular hard disk platter 310a, it increases the likelihood that a given read/write request may be performed without moving the head of physical storage disk 300.

By way of example, as illustrated in FIG. 3, outer circumferential region 380 or a region proximate an outer diameter may be used for the large size stripe region, including, for example, large stripe 382a. The middle circumferential region 370 may be used for the medium size stripe region, including, for example, medium stripe 372a. The inner circumferential region 360 or a region proximate an inner diameter may be used for the small size stripe region, including, for example, small stripe 362a. While three physical region-designations are provided, it will be appreciated that there may be any number of stripe regions, each with their own physical region. In like manner, while only a single stripe is illustrated, it will be appreciated that each stripe region may have multiple stripes contained therein.

In some embodiments, this same principle may be expanded across multiple of the one or more annular hard disk platters 310a-e of physical storage disk 300. For example, in a physical storage disk 300 including five annular hard disk platters 310a-310e, the inner region of all five annular hard disk platters 310a-e may be utilized for small sized stripe regions and the outer region of all five annular hard disk platter 310a-e may be utilized for large sized stripe regions.

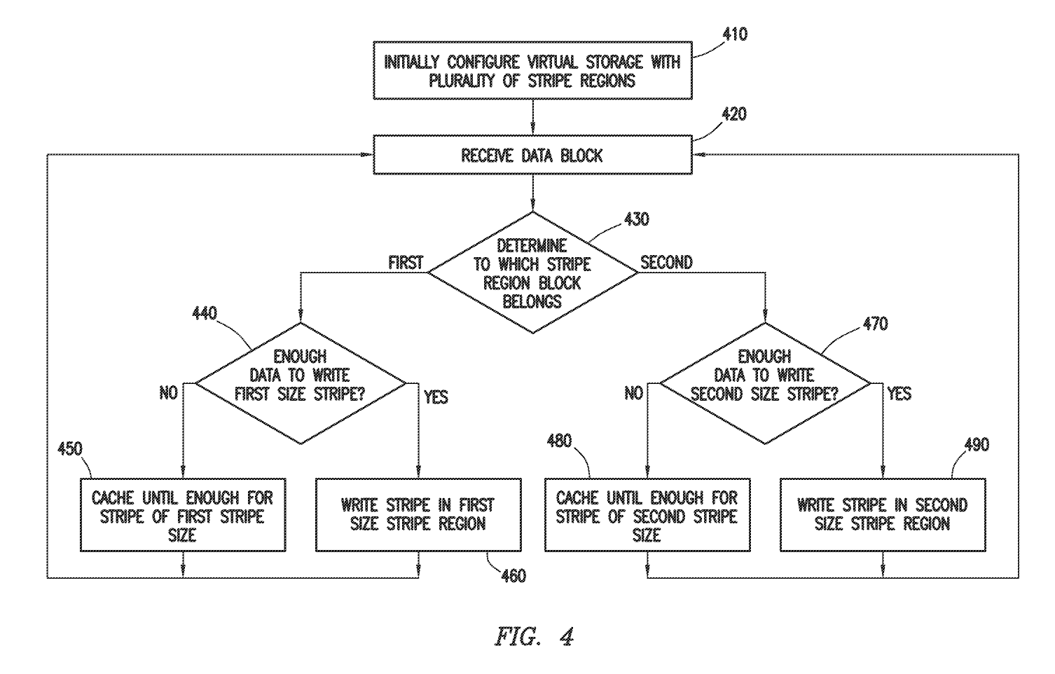

FIG. 4 illustrates an example method, in accordance with some embodiments of the present disclosure. At operation 410, a virtual storage disk is initially configured to include a plurality of stripe regions. As described above, this may include formatting one or more physical hard disk drives to operate as a virtual storage disk, and designating certain regions of the one or more physical disks as corresponding to a particular stripe size. For example, a region of annular hard disk platters proximate an internal diameter of the annular hard disk platters may be designated as a small size stripe region. This may also include the generation of a region mapping table indicating what physical regions of a physical storage disk correspond to a particular stripe size such that when the storage controller writes a stripe of a given size, the corresponding physical region is utilized. For convenience in describing a simplified embodiment of the present disclosure, only two sizes of stripe regions are considered. It will be appreciated that any number of stripe regions may be included within the scope of the present disclosure.

At operation 420, the storage controller receives a write request including a data block from an application. This application may include one or more operating systems, file systems, traditional applications, or the like. In like manner, the write request may come from one or more virtual machines operating on an information handling system running the application. At operation 430, the storage controller determines to which of the plurality of stripe regions the data block belongs. As articulated above, this determination may be done in a variety of ways, including, but not limited to, the application including the size of the data block in the write request, the storage controller monitoring the size of the data block in the write request, or the storage controller maintaining a normal write request size for the application. The determination of the normal write request size for a given application may be done in a variety of ways. This may include, but is not limited to, the application self-reporting to the storage controller the stripe size that it prefers, the storage controller periodically or continually monitoring the size of the data blocks in the application's write requests, or designating the application in a particular class of applications that utilize a comparable data block size in their write requests.

At operation 430, if it is determined that the data block from the write request belongs to the first stripe size region, the method proceeds to operation 440. At operation 440, a determination is made as to whether the storage controller has received sufficient data to complete a full stripe of the given stripe size. This may be performed in a number of ways. In some embodiments, if a one to one mapping of data blocks to stripe segments is utilized, the storage controller may determine whether the full number of data blocks has been received to complete a stripe. For example, referencing the implementation illustrated in FIG. 2, the storage controller may determine whether three data blocks have been received. This may be independent of whether the three write requests require the entire available space for the stripe, because each stripe segment contains one corresponding data block. In other embodiments, the storage controller may monitor the size of the data blocks of the write requests received rather than the number of write requests received determining if a sufficient volume of data has been receive to complete a stripe.

Regardless of the approach utilized, if it is determined at operation 440 that there are insufficient data blocks (either by volume or number) to complete a stripe of the size for the first size stripe region, at operation 450 storage controller caches or otherwise temporarily stores the data block until sufficient data blocks have been received to complete a stripe of the appropriate size. Once the data block has been cached, the storage controller awaits another write request, returning to operation 420 when an additional data block is received.

In like manner, if it is determined at operation 440 that there are sufficient data blocks (either by volume or number) to complete a stripe of the size for the first size stripe region, at operation 460 the storage controller then proceeds to write the stripe of data to the virtual disk in the first size stripe region. In writing the stripe, a single stripe element is placed on each of the physical storage disks. As described above, in some embodiments, each data block may correspond to one stripe element, but need not do so. Additionally, some of the stripe elements may be part of a protection scheme and utilized as parity, such as Aₚ or A_{q}. Once the storage controller completes writing the stripe, the storage controller awaits additional data blocks and the process returns to operation 420 when an additional data block is received.

The method of FIG. 4 follows a similar process if it is determined at operation 430 that the data block belongs to the second size stripe region. At operation 470, the storage controller determines whether there are sufficient data blocks (either by volume or number) to complete a stripe of the second size for the second size stripe region. If it is determined that there are insufficient data blocks to complete a stripe of the second size, at operation 480 the storage controller caches or otherwise temporarily stores the data block until there are sufficient data blocks to complete a stripe. The storage controller than waits until an additional data block is received, and then proceeds to operation 420 where a data block is received.

If it is determined at operation 470 that there is a sufficient amount of data blocks (either by volume or by number), then at operation 490 the storage controller writes a stripe of the second size in the second size stripe region. In writing the stripe, a single stripe element is placed on each of the physical storage disks. Once the storage controller completes writing the stripe, the storage controller awaits additional data blocks and the process returns to operation 420 when an additional data block is received.

With respect to the operations articulated in FIG. 4, it will be appreciated that not all of the operations shown need be performed and other operations not shown may also be performed. For example, operation 410 may be omitted and the process may still fall within the scope of the present disclosure. As another example, an additional branch for a third size stripe region may be included. Additionally, the order of certain operations may be changed.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising:
receiving, by a storage controller, a first data block from a first application;
receiving, by the storage controller, a second data block larger than the first data block from a second application;
writing, by the storage controller based on a size of the first data block, the first data block to a first data stripe spanning a plurality of data storage resources associated with a virtual storage disk, the first data stripe including one stripe element of a first stripe element size on each of the plurality of data storage resources; and
writing, by the storage controller based on a size of the second data block, the second data block to a second data stripe spanning the plurality of data storage resources, the second data stripe including one stripe element of a second stripe element size on each of the plurality of data storage resources;
wherein the second stripe element size is larger than the first stripe element size.

2. The method of claim 1, wherein:
the first data stripe is associated with a first stripe region of the virtual storage disk, the first stripe region including an area on each of the plurality of data storage resources initially configured with contiguous data stripes having stripe elements of the first stripe element size; and
the second data stripe is associated with a second stripe region of the virtual storage disk, the second stripe region including an area on each of the plurality of data storage resources initially configured with contiguous data stripes having stripe elements of the second stripe element size.

3. The method of claim 2, wherein the virtual storage disk further comprises a third stripe region including an area on each of the plurality of data storage resources initially configured with contiguous data stripes having stripe elements of a third stripe element size larger than the first stripe element size and the second stripe element size.

4. The method of claim 3, wherein:
the virtual storage disk comprises no more than three stripe regions;
the first stripe element size is 64 kilobytes (KB);
the second stripe element size is 256 KB; and
the third stripe element size is 512 KB.

5. The method of claim 2, wherein:
the plurality of data storage resources comprises a plurality of hard disk drives;
each hard disk drive includes at least one annular hard disk platter configured to store data; and
the first stripe region and the second stripe region of the virtual storage disk span the annular hard disk platters of each hard disk drive.

6. The method of claim 5, wherein the first stripe region spanning the annular hard disk platters is arranged proximate an inner diameter of each of the annular hard disk platters, and the second stripe region spanning the annular hard disk platters is arranged proximate an outer diameter of each of the annular hard disk platters.

7. The method of claim 2, wherein:
the virtual storage disk comprises a redundant array of independent disks (RAID) technology;
a first parity block associated with the RAID technology is stored in a stripe element of the first data stripe; and
a second parity block associated with the RAID technology is stored in a stripe element of the second data stripe.

8. The method of claim 7, wherein the RAID technology is RAID level six (6).

9. An apparatus comprising:
a processor; and
a computer-readable medium comprising instructions that, when read and executed by the processor, are configured to cause the processor to:
receive a first data block from a first application;
receive a second data block larger than the first data block from a second application;
write, based on a size of the first data block, the first data block to a first data stripe spanning a plurality of data storage resources associated with a virtual storage disk, the first data stripe including one stripe element of a first stripe element size on each of the plurality of data storage resources; and
write, based on a size of the second data block, the second data block to a second data stripe spanning the plurality of data storage resources, the second data stripe including one stripe element of a second stripe element size on each of the plurality of data storage resources;
wherein the second stripe element size is larger than the first stripe element size.

10. The apparatus of claim 9, wherein:
the first data stripe is associated with a first stripe region of the virtual storage disk, the first stripe region including an area on each of the plurality of data storage resources initially configured with contiguous data stripes having stripe elements of the first stripe element size; and
the second data stripe is associated with a second stripe region of the virtual storage disk, the second stripe region including an area on each of the plurality of data storage resources initially configured with contiguous data stripes having stripe elements of the second stripe element size.

11. The apparatus of claim 10, wherein:
the virtual storage disk further comprises a third stripe region including an area on each of the plurality of data storage resources initially configured with contiguous data stripes having stripe elements of a third stripe element size larger than the first stripe element size and the second stripe element size;
the first stripe element size is 64 kilobytes (KB);
the second stripe element size is 256 KB; and
the third stripe element size is 512 KB.

12. The apparatus of claim 10, wherein:
the plurality of data storage resources comprises a plurality of hard disk drives;
each hard disk drive includes at least one annular hard disk platter configured to store data; and
the first stripe region and the second stripe region of the virtual storage disk span the annular hard disk platters of each hard disk drive.

13. The apparatus of claim 12, wherein the first stripe region spanning the annular hard disk platters is arranged proximate an inner diameter of each of the annular hard disk platters, and the second stripe region spanning the annular hard disk platters is arranged proximate an outer diameter of each of the annular hard disk platters.

14. The apparatus of claim 10, wherein:
the virtual storage disk comprises a redundant array of independent disks (RAID) technology;
a first parity block associated with the RAID technology is stored in a stripe element of the first data stripe; and
a second parity block associated with the RAID technology is stored in a stripe element of the second data stripe.

15. The apparatus of claim 14, wherein the RAID technology is RAID level six (6).

16. An article of manufacture comprising:
a machine-readable medium; and
instructions on the machine-readable medium that, when read and executed by a processor, are configured to cause the processor to:
receive a first data block from a first application;
receive a second data block larger than the first data block from a second application;
write, based on a size of the first data block, the first data block to a first data stripe spanning a plurality of data storage resources associated with a virtual storage disk, the first data stripe including one stripe element of a first stripe element size on each of the plurality of data storage resources; and
write, based on a size of the second data block, the second data block to a second data stripe spanning the plurality of data storage resources, the second data stripe including one stripe element of a second stripe element size on each of the plurality of data storage resources;
wherein the second stripe element size is larger than the first stripe element size.

17. The article of claim 16, wherein:
the first data stripe is associated with a first stripe region of the virtual storage disk, the first stripe region including an area on each of the plurality of data storage resources initially configured with contiguous data stripes having stripe elements of the first stripe element size; and
the second data stripe is associated with a second stripe region of the virtual storage disk, the second stripe region including an area on each of the plurality of data storage resources initially configured with contiguous data stripes having stripe elements of the second stripe element size.

18. The article of claim 17, wherein:
the virtual storage disk further comprises a third stripe region including an area on each of the plurality of data storage resources initially configured with contiguous data stripes having stripe elements of a third stripe element size larger than the first stripe element size and the second stripe element size;
the first stripe element size is 64 kilobytes (KB);
the second stripe element size is 256 KB; and
the third stripe element size is 512 KB.

19. The article of claim 17, wherein:
the plurality of data storage resources comprises a plurality of hard disk drives;
each hard disk drive includes at least one annular hard disk platter configured to store data;
the first stripe region and the second stripe region of the virtual storage disk span the annular hard disk platters of each hard disk drive;
the first stripe region spanning the annular hard disk platters is arranged proximate an inner diameter of each of the annular hard disk platters; and
the second stripe region spanning the annular hard disk platters is arranged proximate an outer diameter of each of the annular hard disk platters.

20. The article of claim 10, wherein:
the virtual storage disk comprises redundant array of independent disks (RAID) level six (6) technology;
a first two parity blocks associated with the RAID level six (6) technology are stored in two stripe elements of the first data stripe; and
a second two parity blocks associated with the RAID level six (6) technology are stored in two stripe elements of the second data stripe.
